(19) United States
(12) Patent Application Publication
(10) Pub. No.: US 2004/0237369 A1
(43) Pub. Date: Dec. 2, 2004

(54) Profile moulding intended to be mounted at the front edge of a shelf and method for manufacturing

(76) Inventor: Tomas Andersson, Timra (SE)

Correspondence Address: SUGHRUE MION, PLLC, 2100 PENNSYLVANIA AVENUE, N.W., SUITE 800, WASHINGTON, DC, 20037, US

(21) Appl. No.: 10/494,629

(22) PCT Filed: Nov. 6, 2002
(86) PCT No.: PCT/SE02/02017

(30) Foreign Application Priority Data
Nov. 8, 2001 (SE) 0103712-6

(51) Int. Cl. G09F 3/18

(52) U.S. Cl. 40/661.03

(57) ABSTRACT

Profiled strip intended to be attached to the front edge of a shelf, which shelf is made with a row of openings next to this edge. The profiled strip has a mounting part with an upper flange and a lower flange adapted to receive between them a front edge portion of the shelf and a part made as a label-holder pocket or for supporting separate label-holder pockets. The upper flange of the mounting part is adapted to bear against the upper surface of the shelf and is made with a series of teeth along its rear edge. These teeth form such an angle with the rest of the flange that, when the profiled strip is mounted on a shelf provided with openings, they will project down into these openings and fix the profiled strip to the shelf.

### FIELD OF THE INVENTION

The present invention relates to a profiled strip intended to be attached to the front edge of a shelf, which shelf is made with a row of openings next to said edge, the profiled strip being made with a mounting part with an upper flange and a lower flange adapted to receive between them a front edge portion of the shelf and a part made as a label-holder pocket or for supporting separate label-holder pockets.

The invention also relates to a method for manufacturing such a profiled strip.

### BACKGROUND OF THE INVENTION

Extruded profiled strips of the type mentioned above are used widely in shops, department stores and the like, where goods and products are kept and displayed on shelves, for supporting labels or the like with price and product information. Such labels can be placed either in pockets which are made in one piece with the profiled strip or in separate pocket-like holders which are mounted on the profiled strip. Such a profiled strip can also be used for carrying other types of sales promotion messages, for example in the form of what are known as flags or shelf talkers.

In many cases, shelves for shop shelving are manufactured from a metal sheet which is bent into the desired shape, for example so that what is known as a C-groove, which runs along the front edge of the shelf, is formed. There are shelves such as this on the market, in which the height of the front edge of the shelf varies relatively greatly from one shelf to another. This creates problems when it is desired to mount an extruded profiled strip which is intended to be fixed to the shelf by means of an upper mounting flange and a lower mounting flange which are to grip around the front edge portion of the shelf. If the height of the shelf is too great, it is not possible to mount the profiled strip, and if the height is too small, the fixing of the profiled strip to the shelf is too weak.

### THE OBJECT OF THE INVENTION

One object of the present invention is to produce a profiled strip which can be mounted very easily and securely even on shelves of the type mentioned above with a height which varies within certain limits.

The invention is based on the knowledge that there are sheet-metal shelves on the market which are, for other purposes, made with a series of openings next to the front edge of the shelf and the realization that these openings can also be used for bringing about secure fixing of a profiled strip along the front edge of the shelf.

Another object of the invention is to provide a method which allows simple manufacture of a profiled strip for easy and secure mounting on such shelves provided with openings.

The first of the objects of the invention mentioned above is achieved by means of a profiled strip of the type indicated in the first paragraph, which, according to the present invention, is characterized in that the upper flange of the mounting part is adapted to bear against the upper surface of the shelf and is made with a series of teeth along its rear edge, and in that these teeth form such an angle with the rest of the flange that, when the profiled strip is mounted on a shelf provided with openings, they will project down into said openings and fix the profiled strip to the shelf.

By making use of a profiled strip with projecting teeth which engage with openings in the shelf, secure fixing of the profiled strip to the shelf is achieved even if the height of the shelf deviates slightly from a nominal dimension.

It is preferred that said engagement teeth, which form an angle with the rest of the flange, have been produced by punching-out in a continuous flange of an extruded profiled strip.

Further features of the profiled strip according to the invention and the especially characteristic features of a method for its manufacture emerge from following patent claims.

The invention will be described in greater detail below with reference to the embodiment shown by way of example in the accompanying drawing.

### BRIEF DESCRIPTION OF THE DRAWING FIGURES

FIG. 1 is a perspective view of a front part of a shelf.

FIG. 2 is a perspective view of a profiled strip according to the invention intended to be mounted on the shelf according to FIG. 1.

FIGS. 3 and 4 are side views of the profiled strip according to FIG. 2 and, respectively, the shelf according to FIG. 1 with the profiled strip mounted.

### DETAILED DESCRIPTION OF A PREFERRED EMBODIMENT

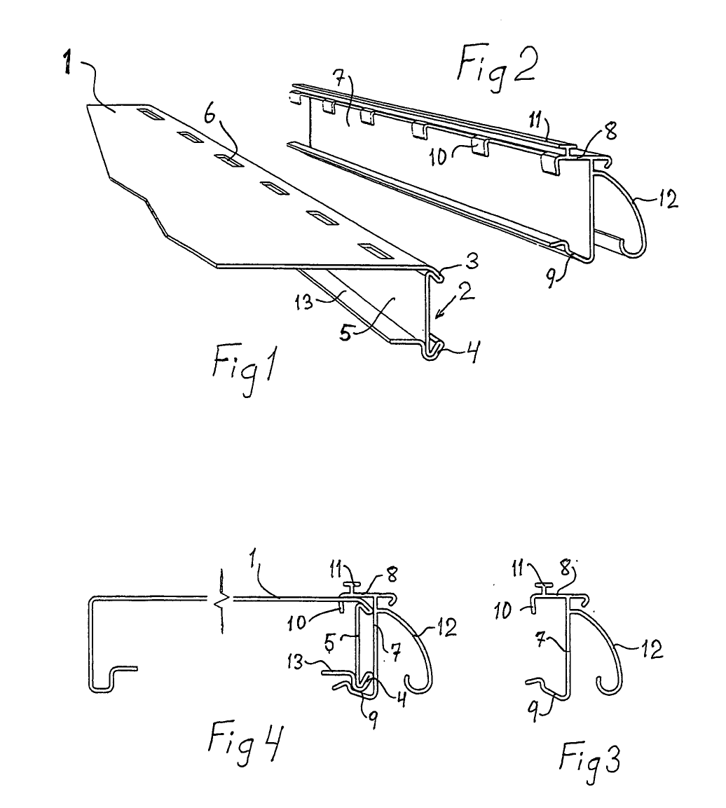

In FIG. 1, reference number 1 designates a shelf made from a metal sheet, which is bent to form a front edge portion of the shelf which in this case is in the form of what is known as a C-groove 2, which is formed by upper and lower flanges 3 and, respectively, 4 and a back portion 5. The flanges 3 and 4 consist of bent-over sheet-metal portions. Running along the front edge of the shelf is a series of openings 6, which are arranged primarily for other purposes not described herein. However, the invention is based on the knowledge that these openings can also be used for secure fixing of a profiled strip to the front edge of the shelf.

An embodiment of a profiled strip 7 for this purpose is shown in FIG. 2. The profiled strip is of the general type which is made with an upper and a lower mounting flange 8 and, respectively, 9, which flanges are intended to be pressed firmly over a front edge portion of a shelf 1. In this embodiment, the lower flange 9 is shaped so as to be capable of bringing about locking engagement with the lower flange 4 of the shelf 1. In a corresponding way, the upper mounting flange 8 is essentially horizontal so as to be capable of bearing against the upper, plane surface of the shelf 1. Since, as mentioned above, the height of the front edge with the C-groove 2 of the shelf 1 can vary from one shelf to another, the flanges 8 and 9 do not in many cases afford sufficiently secure locking of the profiled strip 7 to the shelf 1.

In order to solve this problem, the flange 8 of the profiled strip is, according to the present invention, made with a series of teeth 10 which project in a downward direction from the plane of the rest of the flange 8. The teeth are arranged with the same spacing as the openings 6 in the shelf. In the example shown, the teeth 10 essentially form a right angle with the flange 8 (see also FIG. 3). Other angles, both larger and smaller, can be used, however, depending on the application concerned.

When the profiled strip 7 is mounted on the shelf 1, the front edge portion of the shelf will be received between the mounting flanges 8 and 9 of the profiled strip, and the teeth 10 will enter into locking engagement with the openings 6 in the shelf 1 (see FIG. 4). The profiled strip 7 will then be retained very securely on the shelf and can be used for carrying the desired information material and also dividers for the shelf. For the latter purpose, the profiled strip is made with a T-shaped rail 11 along the upper mounting flange 8. Dividers can be mounted on this in desired positions along the shelf, as described in, for example, SE 0001295-5. In the embodiment shown, the other part 12 is intended to support label-holder pockets, which are fastened over the curved part 2, as is also described in, for example, said Swedish patent application mentioned above.

The invention is not, however, limited to mounting a profiled strip with the rail 11 shown or the part 12, but the profiled strip can have a different design which is adapted to the requirement concerned. The rail 11 can therefore be dispensed with entirely, and the part 12 can be in the form of a longitudinal label-holder pocket. Furthermore, the lower mounting flange 9 has to be adapted depending on the shape of the shelf concerned. It is of course also possible for this flange to be made with upwardly projecting teeth of small height, which can, for example, bear against the rear edge of the flange-shaped part 13 or equivalent of a sheet-metal shelf.

From the point of view of cost, it should be possible for a profiled strip according to the invention to be manufactured by extrusion of a suitable material, such as plastic or aluminum. In this connection, however, it is not possible during the extrusion to produce teeth 10 of the type shown in FIG. 2. According to the present invention, the profiled strip is therefore manufactured in two operations, the first operation comprising extrusion of a profiled strip with a flange running at a certain angle to the mounting flange 8, and suitably with a width which is the same as the height of the teeth 10. In the second operation, material portions of this continuous flange are removed by punching, so that remaining portions form teeth 10 with the desired width and spacing. Such a punching operation can be performed easily in connection with extrusion of the profiled strip. The same technique can also be used if the profiled strip is shaped by hot bending.

The invention has been described above in connection with the embodiment shown by way of example in the accompanying drawing. However, this can be varied in different respects within the scope of the patent claims; this applies to inter alia the exact shapes of the various profiles.

1. A profiled strip intended to be attached to the front edge of a shelf, which shelf is made with a row of openings next to said edge, the profiled strip being made with a mounting part with an upper flange and a lower flange adapted to receive between them a front edge portion of the shelf and a part made as a label-holder pocket or for supporting separate label-holder pockets, characterized in that the upper flange of the mounting part is adapted to bear against the upper surface of the shelf and is made with a series of teeth along its rear edge, and in that these teeth form such an angle with the rest of the flange that, when the profiled strip is mounted on a shelf provided with openings, they will project down into said openings and fix the profiled strip to the shelf.

2. The profiled strip as claimed in claim 1, characterized in that the profiled strip is extruded, and in that the teeth have been produced by a punching operation.

3. The profiled strip as claimed in claim 1, characterized in that the lower mounting flange is made so as to be capable of gripping over a lower edge portion of a shelf made from a bent metal sheet.

4. A method for manufacturing a profiled strip intended to be attached to the front edge of a shelf, which shelf is made with a row of openings next to said edge, the profiled strip being made with a mounting part with an upper flange and a lower flange adapted to receive between them a front edge portion of the shelf, characterized in that the upper flange of the mounting part of the profiled strip is made with a series of teeth along its rear edge, and in that these teeth are produced by punching-out in a continuous flange of an extruded profiled strip.

5. The method as claimed in claim 4, characterized in that said teeth are punched out in a portion of the upper mounting flange of an extruded profiled strip, which portion is extruded so that it forms an angle with the other part of said mounting flange.
